(19) United States
(12) Patent Application Publication
(10) Pub. No.: US 2021/0233095 A9
(43) Pub. Date: Jul. 29, 2021

(54) SYSTEMS AND METHODS FOR PREDICTING SUBSCRIBER CHURN IN RENEWALS OF SUBSCRIPTION PRODUCTS AND FOR AUTOMATICALLY SUPPORTING SUBSCRIBER-SUBSCRIPTION PROVIDER RELATIONSHIP DEVELOPMENT TO AVOID SUBSCRIBER CHURN

(71) Applicant: AON GLOBAL OPERATIONS SE, SINGAPORE BRANCH, Singapore (SG)

(72) Inventor: Trevor DOHERTY, Dublin (IE)

(73) Assignee: AON GLOBAL OPERATIONS SE, SINGAPORE BRANCH, Singapore (SG)

(21) Appl. No.: 16/795,339

(22) Filed: Feb. 19, 2020

Related U.S. Application Data
(60) Provisional application No. 62/808,663, filed on Feb. 21, 2019.

(51) Int. Cl. G06Q 30/02; G06N 20/00

(52) U.S. Cl. CPC G06Q 30/0201; G06N 20/00

(57) ABSTRACT

In an illustrative embodiment, systems and methods for predicting subscriber churn include machine learning algorithm(s) for classifying the subscriber's decision to stay with the present subscription provider or to switch (churn) to a new provider. The machine learning algorithms may include a logistic regression/neural network for modeling churn propensity in subscribers. The churn risk analysis systems and methods may identify a group of subscribers most likely to churn. Further, the churn risk analysis systems and methods may identify a group of subscribers least likely to churn. The identified subscribers may be presented to a representative of the subscription provider, for example through a user interface.

### RELATED APPLICATION

This application claims priority to U.S. Provisional Patent Application Ser. No. 62/808,663, entitled “Systems and Methods for Predicting Subscriber Churn in Renewals of Subscription Products and for Automatically Supporting Subscriber-Subscription Provider Relationship Development to Avoid Subscriber Churn,” filed Feb. 21, 2019. The above identified application is hereby incorporated by reference in its entirety.

### BACKGROUND

Success in sales often relies upon repeat business and expansion of business from an established client basis. Many products are renewed on a periodic basis, such as Internet and media subscriptions, insurance policies, and gym memberships. When the renewal period is approaching, businesses may provide reminders and offers for subscribers or members to renew the relationship. However, unless a history of communications between the organization and the subscriber has been established, for example through customer service interactions and/or survey responses, the business may have very little insight into whether a particular subscriber or group of subscribers is likely to switch to an alternative provider.

The inventors recognized a need for a method and system to predict subscriber churn and to identify those subscribers most likely to switch to a different provider. Further, the inventors recognize that, if the subset of subscribers most likely to leave can be predicted, automated or semi-automated campaigns may be directed to these subscribers to increase the likelihood of maintaining the subscriber for another product cycle.

### SUMMARY OF ILLUSTRATIVE EMBODIMENTS

In some embodiments, systems and methods for predicting subscriber churn are developed to model relationship factors similar to those involved in the psychology of interpersonal relationships and the likelihood of extramarital affairs in determining the health of the relationship a customer has with the subscription provider. The model features, in some examples, can include subscriber attributes, provider attributes, and relationship properties. The features, in some implementations, include population characteristics regarding the general population of customers for the products of the subscription provider. For example, the population characteristics can be derived from demographic information and/or from prior transactions captured by a subscription exchange platform, such as an insurance exchange platform. Additionally, other features such as provider attributes and relationship properties can be derived from the transactional records maintained by the exchange platform.

In one aspect, systems and methods for predicting subscriber churn include one or more machine learning algorithms designed to classify the subscriber's binary decision to stay with the present subscription provider or to switch (i.e., churn) to a new subscription provider. In some embodiments, the machine learning algorithms include a logistic regression/neural network for modeling churn propensity in subscribers. The machine learning algorithms, in some embodiments, are executed by one or more churn risk analysis engines. The churn risk analysis engine(s) may identify a group of subscribers most likely to churn. Further, the churn risk analysis engine(s) may identify a group of subscribers least likely to churn. The identified subscribers may be presented to a representative of the subscription provider, for example through a user interface.

In one aspect, the systems and methods for predicting subscriber churn include one or more recommendations engines for recommending one or more interventions designed to avoid churn of those subscribers identified as being most likely to switch to a different subscription provider. The recommendations engine(s) may present one or more options to a user at a user interface for review. The interventions, in some examples, can include personal contact, such as telephone or email contact, from a subscription provider representative, a promotional offer or introduction of a promotional campaign for subscription renewal, a gift such as an item provided in the mail, and/or a promotional offer or introduction of a promotion campaign for subscription expansion to supply greater options, benefits, or services to the subscriber. In some embodiments, the recommendations engine(s) automatically launch an intervention such as a promotional campaign to entice those subscribers most likely to churn to stay.

In one aspect, the systems and methods for predicting subscriber churn include one or more validation engines to gauge effectiveness of interventions and/or predictions made by the machine learning algorithms (e.g., through the churn risk analysis engine(s)). The validation engines may analyze actual outcomes in light of predicted outcomes to determine whether the models accurately predicted churn outcome and/or whether a portion of churn was likely avoided through application of intervention with an identified at risk subscriber population.

In one aspect, the systems and methods for predicting subscriber churn include a feature learning engine for identifying features correlating to subscriber churn. The features may include subscriber features, provider features, product features, or relationship features. Further, the features may include one or more external features such as seasonal flux or market stress.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIGS. 1A-1B illustrate a flow diagram of a process for identifying customers likely to churn away from a provider and for mitigating this risk;

FIG. 2 is an operational flow diagram of a process for validating one or more churn models and for validating recommended response(s) for mitigating this risk;

FIG. 3 is a block diagram of a platform and environment for mitigating churn risk in subscribers of subscription products;

FIG. 4 is an operational flow diagram of a process for identifying feature sets relevant to client churn and for producing new churn prediction models therefrom;

FIG. 5 is a block diagram of an example computing system;

FIG. 6 is a block diagram of an example network environment;

FIG. 7 is a table showing a set of example churn correlation features; and

FIG. 8 is a flow chart of an example process for predicting and mitigating churn.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

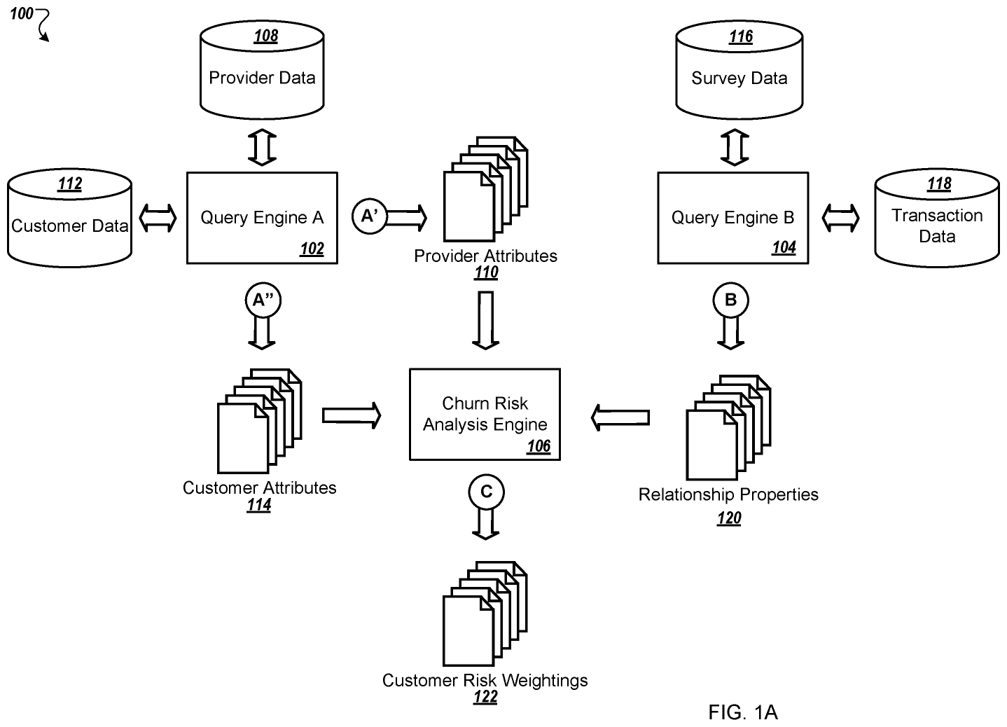

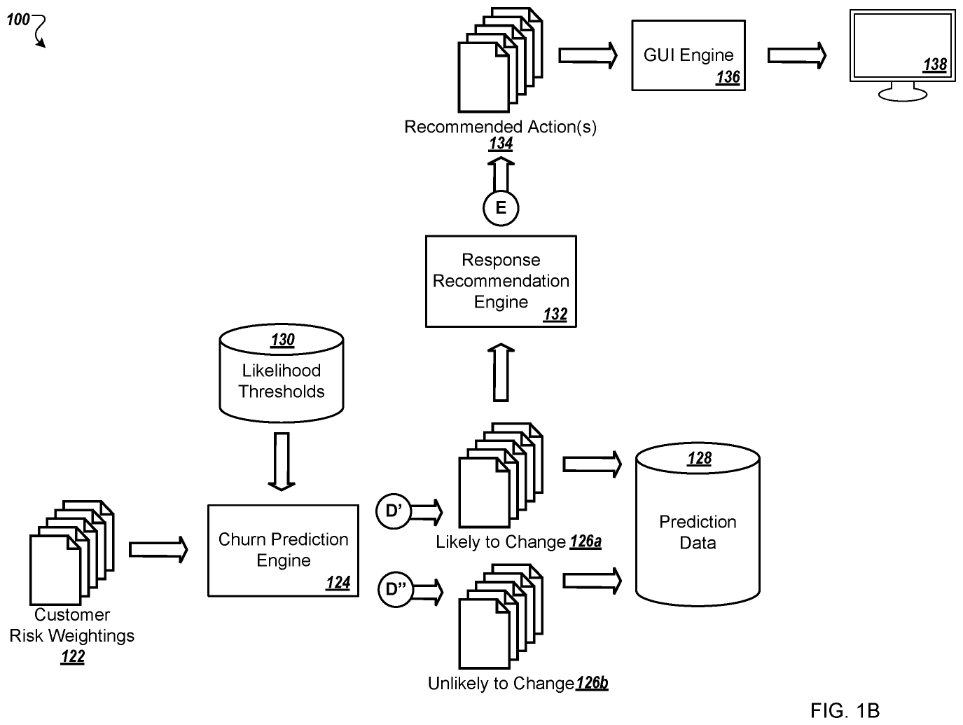

Subscriber churn can relate to customers of a subscription product switching from one provider to another provider at the end of the product cycle (e.g., at time of subscription renewal) and/or dropping the product altogether. Although often the incumbent subscription provider has the benefit over competitors for renewing subscriber business for a coming product cycle, subscribers may elect to churn to a different provider for a variety of reasons, such as cost savings, disappointment in customer service, disappointment in product value, or interest in variations of features offered by competing providers. FIGS. 1A and 1B illustrate an operational flow diagram of an example process 100 for identifying customers likely to churn away from a provider and for supporting the provider in mitigating this risk, thus decreasing subscriber churn. The process 100 may be performed for a set of customers of a subject provider approaching a subscription renewal date to focus the subject provider's retention efforts where it is likely to be most needed. In another example the process 100 may be performed for a set of customers of a subject provider holding a subscription for a particular product or type of product when the subject provider is launching a promotional campaign related to that product or type of product (e.g., launch of an enhanced product that certain customers may prefer over their present product). Further to the example, the outcome of the process 100 may be useful in informing a marketing budget for the promotional campaign. In yet another example, the process 100 may be performed during a calendar period recognized to historically suffer from “seasonal flux” where churn is more likely to occur. Additionally, the process 100 may be performed for a particular customer responsive to an event that may increase likelihood to churn, such as a customer support interaction, to gauge the need for additional positive intervention. Other circumstances and reasons for applying the process 100 are possible.

The various data sets used by the process 100, in some embodiments, are maintained by a subscription exchange platform, such as an insurance exchange platform, providing a transactional environment for multiple providers to engage with customers in providing subscription products or services. In some embodiments, a portion of the data represented in the data sets is accessed through third party systems such as public databases tracking business information or business ratings (e.g., credit ratings, better business bureau ratings, etc.).

Turning to FIG. 1A, in some implementations, the process 100 begins with determining, by a first query engine 102 from provider data 108, provider attributes 110 regarding at least one provider of subscription products. In some examples, the first query engine 102 may access the provider data 108 from a data repository and/or obtain the provider data 108 using web crawling or scraping techniques. The provider attributes 110, in some examples, may include features such as size, breadth of product offerings, age, financial security (e.g., credit rating), and geographic region. Further, the provider attributes 110 may include relative characteristics such as, in some examples, rank within industry or industry segment, market share, and/or one or more consumer ratings such as customer service expertise, claims handling, subscription product value rating/ranking (e.g., within platform or through independent source(s)), subscription product reliability (e.g., within platform or through independent source(s)), and/or date of addition to the subscription exchange platform. Additionally, the provider attributes 110 may include product relevant characteristics such as, in some examples, product distribution methods, subscriber communications methods, payment methods, and/or product features (e.g., product lines, subscription benefits, etc.).

In some implementations, the first query engine 102 determines, from customer data 112, customer attributes 114 regarding present customers of the subject provider. The customer attributes, in some examples, may include features such as size, industry, geographic region, age, and financial security (e.g., credit rating, revenues, etc.). Further, the customer attributes 114 may include relative characteristics such as, in some examples, rank within an industry or industry segment, market share, or date of addition to the subscription exchange platform. In some examples, the first query engine 102 may access the customer data 112 from a data repository and/or obtain the customer data 112 using web crawling or scraping techniques.

In some implementations, a second query engine 104 determines, from survey data 116 and/or transaction data 118, relationship properties 120 regarding a relationship between each customer identified in the customer attributes 114 and at least the subject provider. In some examples, the second query engine 104 may access survey data 116 and/or transaction data 118 from a data repository and/or obtain the survey data 116 and/or transaction data 118 using web crawling or scraping techniques. The transaction data 118 may represent, in some examples, subscription purchase data (e.g., date, product, cost, coverage, etc.), payments data (e.g., dates and amounts of payments, indications of past due payments, type of payment schedule established between customer and provider, etc.), service request data (e.g., insurance claims data), customer support interactions data (e.g., technical support interactions, product support interactions, invoicing or billing support interactions, user information updating interactions, etc.), customer communications data (e.g., calls placed between provider and customer, electronic messages between provider and customer, accesses by customer to customer portal or provider web site, etc.), and/or discount data (e.g., any redeemed offers, coupons, discounted services, repeat customer adjustments, etc. applied to subscription price). Therefore, in some examples, the transaction data 118 reflects any interactions between the customers and providers over the course of the respective product subscription. The survey data 116 may represent customer survey information obtained from at least a portion of the customers through, in some examples, mailings, online surveys, and/or telephone surveys. The survey data may represent relative contentment of each customer with the provider across one or more relationship factors such as, in some examples, product value, provider communications, customer support outcomes, claims handling and/or claims outcomes, product relevance to the customer's changing needs, and the customer's perception of the subject provider's reputation in the industry. The survey data may be combined into one or more survey metrics representing overall contentment and/or contentment in view of each relationship factor.

The relationship properties 120, in some implementations, include (for each customer) one or more products subscribed to by the customer (e.g., diversity of products, product type(s)), a total number of products currently subscribed to by the customer, a start date of the relationship between the customer and the subject provider, whether the customer is a returning customer that churned away from the subject provider at a previous time, and/or a number of times the customer has churned between providers as captured by the transaction data 118 maintained by an exchange platform for subscription services. Further, the relationship properties 120 may include subjective features, such as contentment-based features derived from the survey data 116 or estimated through analysis of the transaction data 118. For example, an insurance claim that took much longer to resolve than typical insurance claim resolution times or that required many more communications between the provider and customer than a typical or average number of communications until claim resolution, may be indicative of likelihood of the customer's discontentment with the claims handling process. In another illustrative example, repeated payment delays or an invoicing dispute may be indicative of the customer's discontentment with the subject provider. Although illustrated as querying data record for the relationship properties 120, in other embodiments, one or more relationship properties 120 are obtained by querying transactional data and then using the transactional data to calculate relationship metrics.

In some implementations, a churn risk analysis engine 106 obtains the provider attributes 110, the customer attributes 114, and the relationship properties 120 and analyzes the information to determine a set of customer risk weightings 122 representing relative propensity for each customer to churn away from the subject provider. The churn risk analysis engine 106 may supply combinations of provider attributes 110, customer attributes 114, and relationship properties 120 as a set of model-specific relationship factors to each of one or more predictive models to calculate churn predictions. The predictive models may be based upon and/or use some of the predictive techniques of an extra-marital affairs prediction model and social exchange theory to analyze the model-specific relationship factors between the subject provider and each customer and to predict whether that set of factors are more or less likely to lead to customer churn. Each model may be implemented as a deep learning neural network. The churn predictions, for example, may be represented in the set of customer risk weightings 122 as a percentage likelihood or a value estimate along a scale (e.g., not likely, somewhat unlikely, neutral, somewhat likely, very likely).

Turning to FIG. 1B, in some implementations, the customer risk weightings 122 can be determined by a churn prediction engine 124 that classifies the customer risk weightings 122 into at least a set of likely to churn customers 126a and a set of unlikely to churn customers 126b. The churn prediction engine 124 may apply one or more likelihood thresholds 130 for separating the customers by relative likelihood to churn. The thresholds 130 may represent values or percentiles. For example, the subject provider may want to focus on the top 10% most likely customers to churn, the top 20% most likely customers to churn, or the top 25% most likely customers to churn as the set of likely to churn customers 126a. Conversely, the set of unlikely to churn customers 126b may include the 10% least likely customers to churn, the 20% least likely customers to churn, or the 25% least likely customers to churn. The likelihood thresholds 130, in some embodiments, are user specified. In other embodiments, the likelihood thresholds are set. In some embodiments, the likelihood thresholds 130 can by dynamically adjusted based on changing attributes of customers and their likelihood of churn. Although illustrated as two sets 126a, 126b, in other implementations, more or fewer sets are provided by the churn prediction engine 124. For example, the churn prediction engine 124 may supply only the set of likely to churn customers 126a. In another example, the churn prediction engine 124 may supply a set of very likely to churn customers (e.g., top 10%) as well as a set of somewhat likely to churn customers (e.g., 80^{th} percentile). As illustrated, the sets of customers 126 are stored in a data store 128.

In the event that the customer risk weightings 122 represent the outcomes of multiple models, in some embodiments, the churn prediction engine 124 combines results to determine a single likelihood rating per customer. For example, the churn prediction engine 124 may calculate an average or a weighted average value to two or more customer risk weightings 122 corresponding to each customer.

The churn prediction engine 124, in some implementations, applies one or more additional weightings to the customer risk weightings 122. In other words, the churn prediction engine 124 may place a proverbial finger on the scale based upon one or more mitigating factors. For example, the churn risk analysis engine 106 can identify a set of key factors related to the customers, subject provider, and the customer-provider relationships, while the churn prediction engine 124 applies one or more weightings based upon a current state of affairs that may be external to the customer, provider, and/or customer-provider relationships such as, in some examples, a seasonal propensity to churn using the present date, a market propensity to churn using fluctuations in market status such as stock market values in the customer, the provider, or the nation/world in general, or other environmental variables. In an illustrative example, an environmental variable may include legislation affecting the market or a new product trend sweeping the industry.

In some implementations, the set of customers likely to churn 126a are obtained by a response recommendation engine 132 for generating one or more recommended actions 134 to mitigate the risk of churn among the customer set 126a. The response recommendation engine 132 may recommend personal contact, marketing email, promotional offer, discount, or another mechanism for enticing each customer of the customer set 126a to remain with the subject provider. The response recommendation engine 132 may group recommended actions, in some embodiments, based upon type of product, length of relationship, or other categorization. In some examples, the recommended actions can be providers (carriers) or subscription product brokers. Certain recommended actions, in some embodiments, are identified by the response recommendation engine 132 due to particular churn factors, such as disappointment in customer service responsiveness. For example, the response recommendation engine 132 may recommend a discount or other benefit responsive to the customer's disappointment in claims handling of an insurance claim. In some examples, the response recommendation engine 132 can determine the recommendations based on learned trends in the likelihood of success of a particular action in mitigating the risk of churn for a particular client with a specific set of characteristics and/or experiences. In this way, the recommended actions can be customized to specific characteristics of the interactions between clients and subscribers.

In some implementations, the recommended actions 134 are formatted for presentation to a user by a graphical user interface (GUI) engine 136. For example, one or more recommended actions may be presented to the user at a display 138 of a remote computing device. The user interface may include the recommendations along with a control configured, upon selection, to automate implementation of the recommended action. Further, in some embodiments, the user may have the ability to select different actions on a per customer basis or per customer grouping basis. In embodiments without the response recommendation engine 132, the customers of the customer set 126a may be presented to the user via the GUI engine 136 and the user may apply discretion in determining appropriate response to mitigate churn.

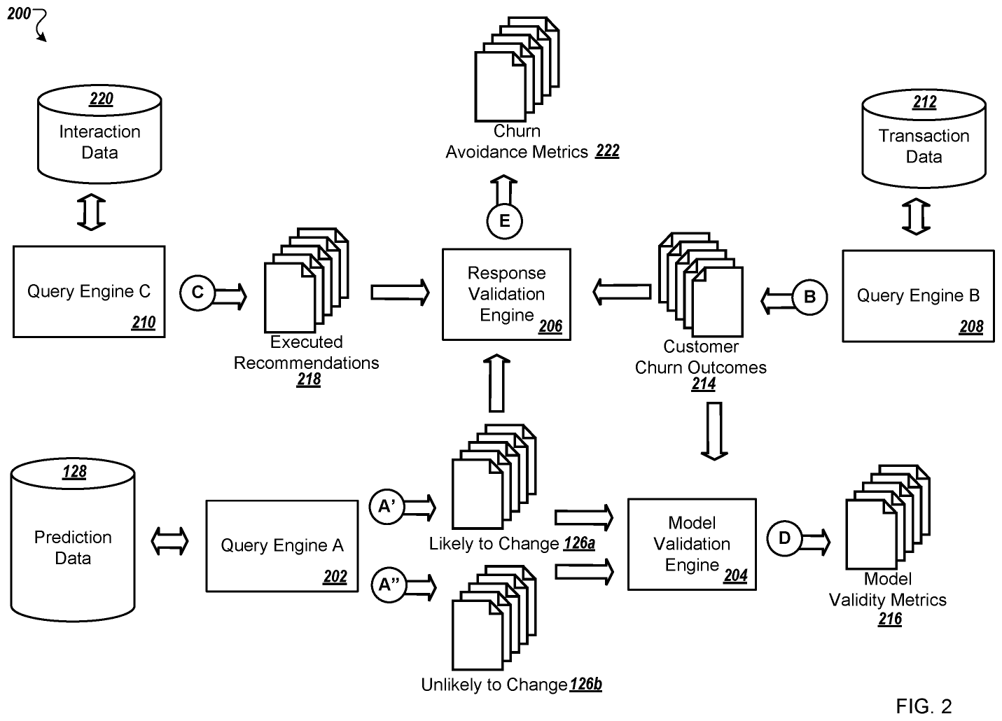

The recommendations applied by the user, in some implementations, are stored as interaction data within the transactional platform (not illustrated). In this manner, the platform may track effectiveness of provider interactions with customers in mitigating customer churn. Turning to FIG. 2, an operational flow diagram illustrates an example process 200 for validation of both model identification of churn likelihood and responses applied by a provider to mitigate churn risk.

In some implementations, the process 200 begins with accessing, by a first query engine 202, the prediction data 128 to obtain the sets of customers 126. Each of the sets of customers 126, in some implementations, are provided to a model validation engine 204 for validating churn predictions with actual churn outcomes. Further, in some implementations, the set of customers predicted likely to churn 126a is provided to a response validation engine 206 to evaluate whether executed recommendations proved effective.

In some implementations, a second query engine 208 accesses transaction data 212 (e.g., such as the transaction data 118 of FIG. 1A but including post renewal period transactions) to identify customer churn outcomes 214. The second query engine 208, for example, may analyze transactional outcomes to determine whether each customer of a set of customers (e.g., the customers of a subject provider as of the pre-renewal period) remained with the subject provider or churned to a new provider (or otherwise failed to renew). Thus, the customer churn outcomes 214 may include at least two outcomes (e.g., remained a customer, did not remain a customer), although the customer churn outcomes 214 may include additional information for refined analysis of outcomes (e.g., remained a customer and renewed the subscription, remained a customer and modified the subscription, became a customer of another provider of the transactional platform, is no longer a customer of a provider of the transactional platform). The customer churn outcomes 214 may be used by both the model validation engine 204 and the response validation engine 206.

In some implementations, the model validation engine 204 evaluates the sets of customer predictions 126a, 126b in view of the customer churn outcomes 214 to identify accuracy of model predictions for each of the models used by the churn risk analysis engine 106 of FIG. 1A to develop the customer risk weightings 122. In other implementations, the customer risk weightings 122 of FIG. 1A are used instead of or in addition to the customer churn outcomes 214 to identify accuracy of model predictions. For example, the customer risk weightings 122 may be directly indicative of model predictions, while the sets of customers 126a, 126b may instead be indicative of the model predictions as adjusted by any weightings applied by the churn prediction engine 124 of FIG. 1B.

The model validation engine 204, in some implementations, generates model validity metrics 216 quantifying the accuracy of predictions made by the models both in identifying those customers most likely to churn and in identifying those customers least likely to churn. The model validity metrics 216, in some examples, may include percentage accurate positive predictions (e.g., customers predicted as likely to churn did churn), percentage accurate negative predictions (e.g., customers predicted as unlikely to churn did not churn), percentage inaccurate positive predictions (e.g., customers predicted as likely to churn did not churn, and percentage inaccurate negative predictions (e.g., customers predicted as unlikely to churn did churn). Further, the model validity metrics 216 may include ratio metrics, such as rate of inaccurate predictions to accurate predictions. The ratio metrics may be formulated in relation to both positive predictions and negative predictions. In some implementations, the model validity metrics 216 further include metrics regarding propensity of customers to churn not predicted as either likely or unlikely to churn. The model validity metrics 216 may be presented to a user in a report format or interactive graphical user interface display.

Since executed recommendations may affect likelihood to churn in the set of customers predicted likely to churn 126a, in some embodiments, the model validation engine 204 is executed using historic data not supplied to a user to encourage customer intervention to mitigate churn. For example, the churn risk analysis engine 106 may be performed upon historic data (e.g., with results of churn already known) and the predictions provided to the model validation engine 204 to validate new model(s) against historic data.

In some implementations, instead of or in addition to the analysis performed by the model validation engine 204, the set of customers predicted as likely to churn 126a is provided to a response validation engine 206, along with the customer churn outcomes 214 and a set of executed recommendations 218. The response validation engine 206 may analyze the churn outcomes 214 in light of the executed recommendations 218 to quantify effectiveness of one or more recommendations executed to avoid churn of the customers predicted must likely to change providers.

In some implementations, a third query engine 210 accesses a data store 220 to obtain the executed recommendations 218 from interaction data 220 representing interactions between certain customers and the subject provider. The interaction data 220, in one example, may include promotional offers successfully delivered to customers (e.g., emails which did not bounce, click-throughs evidencing customer acknowledgment of the promotional offer, application of promotional offers to subscription renewal, etc.). In another example, the interaction data 220 may include record of personal contact (e.g., telephone contact, video chat session, real time text messaging session, etc.) with one or more customers to resolve customer concerns or to provide subscription information to the customer to aid in renewal decision. Further, the interaction data 220 may include survey data representing customer satisfaction with the provider after such personal interaction. Thus, the executed recommendations 218 may include record of attempted interaction (e.g., delivery of a promotion, attempt at personal contact) as well as an outcome of such interaction (e.g., ignoring versus engaging, customer signaling of increased satisfaction versus customer signaling of continued dissatisfaction, etc.).

The response validation engine 206, in some implementations, correlates the executed recommendations 218 with customer churn outcomes 214 for the customer set deemed likely to churn 126a to determine churn avoidance metrics 222. The churn avoidance metrics 222, in some examples, may include calculations representing prevalence of churn outcomes in light of the executed recommendations 218 (e.g., successful interactions within the customer set 126a) versus no executed recommendation (e.g., bounced email, failure of response from customer, etc.). Further, the churn avoidance metrics 222 may include comparisons between outcomes among the set of customers 126a in view of historic prediction to actual outcomes (e.g., as calculated by the model validation engine 204 in view of historic data). In the event of multiple types of customer interventions (e.g., as evidenced in the executed recommendations 218), in some embodiments, the response validation engine 206 determines metrics comparing effectiveness of different types of interventions. The churn avoidance metrics 222 may be presented to a user in a report format or interactive graphical user interface. In some implementations, the churn avoidance metrics 222 can be used to update recommendation data features used by the response recommendation engine 132 in determining the recommended actions 134 presented to providers. In this way, the system can adapt by incorporating feedback regarding how well each of the recommendations work in different contexts. Therefore, the system provides a technical solution to the technical problem of automatically tailoring the recommendations provided to product providers to reduce the risk of client churn and being able to use received knowledge about client churn outcomes and the effectiveness of previously provided recommendations to improve accuracy of recommendations.

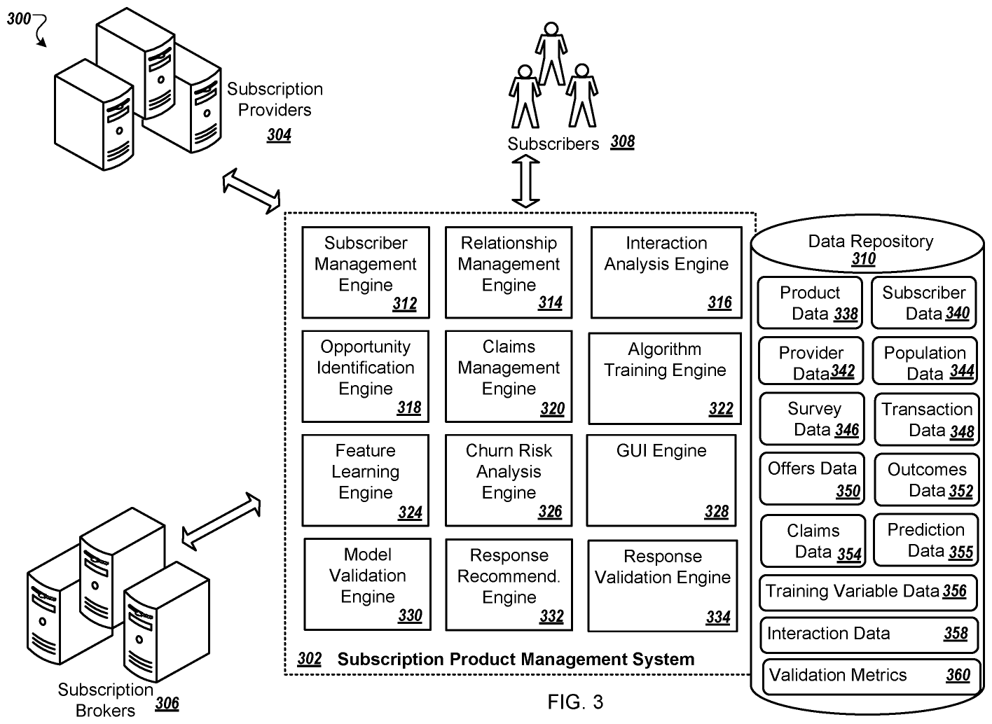

Turning to FIG. 3, a block diagram of an environment 300 for customer churn avoidance is presented. The environment 300 includes a subscription product management system 302, a number of subscription providers 304, and a number of subscribers (customers) 308. In some embodiments, the environment 300 additionally includes a number of subscription brokers 306, such as insurance brokers. The providers 304, subscribers 308, and/or brokers 306 may interface with the subscription product management system 302 through a graphical user interface engine (328) supplying information via a network connection to remote computing devices of the providers 304, subscribers 308, and/or brokers 306. The environment 300, for example, may support the process 100 of FIG. 1A and FIG. 1B and the process 200 of FIG. 2.

In some implementations, the subscription product management system 302 includes a subscriber management engine 312 for collecting and maintaining information regarding the subscribers 308. The subscriber management engine 312 may maintain the subscriber information as subscriber data 340 in a data repository 310. The subscriber data 340, for example, may include demographic information regarding the subscribers 308. This demographic information may further add to population data 344 representing groupings of subscribers 308 by a number of categories such as, in some examples, geographic region, industry, size (e.g., of organization by number of employees or financials data), age, and length of membership within the environment 300.

In some implementations, the subscription product management system 302 includes a relationship management engine 314 for managing relationships between subscribers 308 and providers 304 (with, in some embodiments, the support of intermediary brokers 306). The relationship management engine 314, for example, may support interactions from subscription purchase to subscription renewal between the subscribers 308 and providers 304 (e.g., optionally through intermediary brokers 306). The relationship management engine 314 may collect survey data 346 from subscriber surveys conducted to determine satisfaction of subscribers with subscription products. The relationship management engine 314 may manage promotional offers having offers data 350 for renewing and/or expanding subscription relationships between the subscribers 308 and providers 304. Interactions between the subscribers 308 and brokers 306 and/or providers 304 may be collected by the relationship management engine 314 as interaction data 358.

The subscription product management system 302, in some implementations, includes an opportunity identification engine 318 for identifying subscription renewal opportunities among the subscribers 308. The opportunity identification engine 318, for example, may identify upcoming renewal periods and present a user (e.g., broker 306 or provider 304) within information on opportunities to renew and/or expand relationships with the subscribers 308. The opportunity identification engine 318, further, may identify expansion opportunities, for example, based upon information gleaned from the survey data 346.

In some implementations, the subscription product management system 302 includes a claims management engine 320 for managing claims submitted in relation to subscriptions held by the subscribers 308. The claims management engine 320, for example, may track and manage claims handling involving the providers 304, as stored in claims data 354. The claims, for example, may be managed through the brokers 306. Further, the claims management engine 320 may log interaction data 358 in subscriber interactions related to a claim.

The subscription product management system 302, in some implementations, includes a churn risk analysis engine 326 for analyzing the likelihood of subscriber churn from a present provider 304 to a different subscription provider 304. The churn risk analysis engine 326, for example, may perform a portion of the operations of the process 100 of FIGS. 1A and 1B (e.g., operations performed by the churn risk analysis engine 106). The churn risk analysis engine 326 may analyze subscriber data 340, provider data 342, survey data 346, transaction data 348, claims data 354, and/or interaction data 358 to identify subscribers 308 most likely to churn away from the present provider 304. Further, the churn risk analysis engine 326 may identify subscribers 308 least likely to churn away from the present provider 304. An interaction analysis engine 316, in some embodiments, analyzes the interaction data 358 to identify interactions between the subscribers 308 and providers 304 and/or brokers 306 that may have a bearing upon propensity to churn (e.g., positive interactions leading to lowered likelihood of churn and/or negative interactions leading to heightened likelihood of churn). The output of the churn risk analysis engine 326 may be stored as prediction data 355.

In some implementations, the subscription product management system 302 includes a response recommendation engine 322 for recommending one or more interventions to avoid churn in the subscribers identified by the churn risk analysis engine 326. The response recommendation engine 332, for example, may perform some operations of the process 100 of FIGS. 1A and 1B (e.g., operations performed by the response recommendation engine 132 of FIG. 1B). The response recommendation engine 322, for example, may recommend personalized interactions and/or promotional offers (e.g., as captured in offers data 350) for enticing subscribers to remain with the present provider 304. The recommended responses, in some embodiments, are based in part upon one or more of a product(s) held by a given subscriber 308 (e.g., as identified in product data 338), survey responses by the given subscriber 308 (e.g., as identified in survey data 346), evidence of negative experience with claims handling as evidenced in claims data 354, and length of relationship between the given subscriber 308 and the subject provider 304 (e.g., as evidenced by transaction data 348). The recommended response(s) may be presented to a representative of the subject provider 304 by the GUI engine 328.

In some implementations, the subscription product management system 302 includes a response validation engine 334 for validating whether one or more interventions recommended by the response recommendation engine 332 were successful in avoiding churn among the subscribers 308 identified by the churn risk analysis engine 326. The response validation engine 334, for example, may perform a portion of the operations of the process 200 (e.g., operations of the response validation engine 206). The response validation engine 334 may analyze transaction data 348 to identify actual churn outcomes (e.g., whether or not a subscriber renewed a subscription). The response validation engine 334 may analyze interaction data 358 to identify whether interventions recommended by the response recommendation engine 332 were followed through by the subject provider 304 and/or brokers 306. In some embodiments, the interaction analysis engine 316 analyzes the interaction data 358 to identify churn within subscription holdings among the subscribers 308. The response validation engine 334 may generate validation metrics 360. The metrics may be presented to a user, such as a representative of one of the providers 304, via the GUI engine 328.

Similarly, in some implementations, the subscription product management system 302 includes a model validation engine 330 for validating models used by the churn risk analysis engine 326 in prediction subscriber churn. The model validation engine 330, for example, may perform a portion of the operations of the process 200 (e.g., operations performed by the model validation engine 204). The model validation engine 330 may analyze prediction data 355 in view of actual outcomes evidenced by the transaction data 348. Metrics generated by the model validation engine 330 may be stored as validation metrics 360. The metrics may be presented to a user, such as a representative of one of the providers 304, via the GUI engine 328. In some implementations, the results generated by the model validation engine 330 can be used to update the training data and/or weighting factors used to train the churn risk analysis engine 326 in order to improve accuracy.

The subscription product management system 302, in some implementations, includes a feature learning engine 324 for identifying features corresponding to churn outcomes. The feature learning engine 324, for example, may gather information such as subscriber characteristics from the subscriber data 340, product characteristics from the product data 338, and provider characteristics from the provider data 342 relevant to historic churn events (e.g., characteristics corresponding to a time of each historic churn event) for a number of subscribers 308 and/or former subscribers of the subscription product management system. The feature learning engine 324 may analyze the characteristics to identify patterns indicative of likelihood to churn. Further, the feature learning engine 324 may analyze claims data 354 to identify patterns in claims handling, survey data 346 to analyze patterns in survey responses and/or interaction data 358 to analyze patterns of provider-subscriber interactions to identify patterns indicative of likelihood to churn. The features may be individual or combined. For example, the feature learning engine 324 may identify that subscribers having both characteristic A and claims handling outcome B have a greater likelihood to churn. The features identified by the feature learning engine 324 may be used to create new prediction models for use by the churn risk analysis engine 326 in predicting subscriber churn.

The feature learning engine 324, in some implementations, identifies variable features applicable to churn outcomes in some circumstances. The variable features, in some examples, may include seasonality, financial market volatility, labor market volatility, or other factors external to the environment 300 that may have an effect on subscriber behavior.

The feature learning engine 324, in some embodiments, derives factors related to the providers 304 that the providers 304 may improve upon to reduce subscriber churn. In some examples, the feature learning engine 324 may identify product diversity, financial security, and/or customer service behaviors indicative of lower subscriber churn rates. The feature learning engine 324 may supply such information to the user, for example through the response recommendation engine 332 and/or GUI engine 328.

In some implementations, the subscription product management system 302 includes an algorithm training engine 322 for training models for use by the churn risk analysis engine 326. The algorithm training engine 322, for example, may adjust preexisting models based upon additional feature correlations derived by the feature learning engine 324. In another example, the algorithm training engine 322 may add training data to an existing model based upon actual outcomes in churn. The model validation engine 330, for example, may provide additional information for refining the functionality of one or more models used by the churn risk analysis engine 326 through the algorithm training engine 322. In some examples, the additional information for improving the accuracy of the models can include results from the model validation engine 330 indicating an accuracy of the predictions generated by the churn risk analysis engine 326.

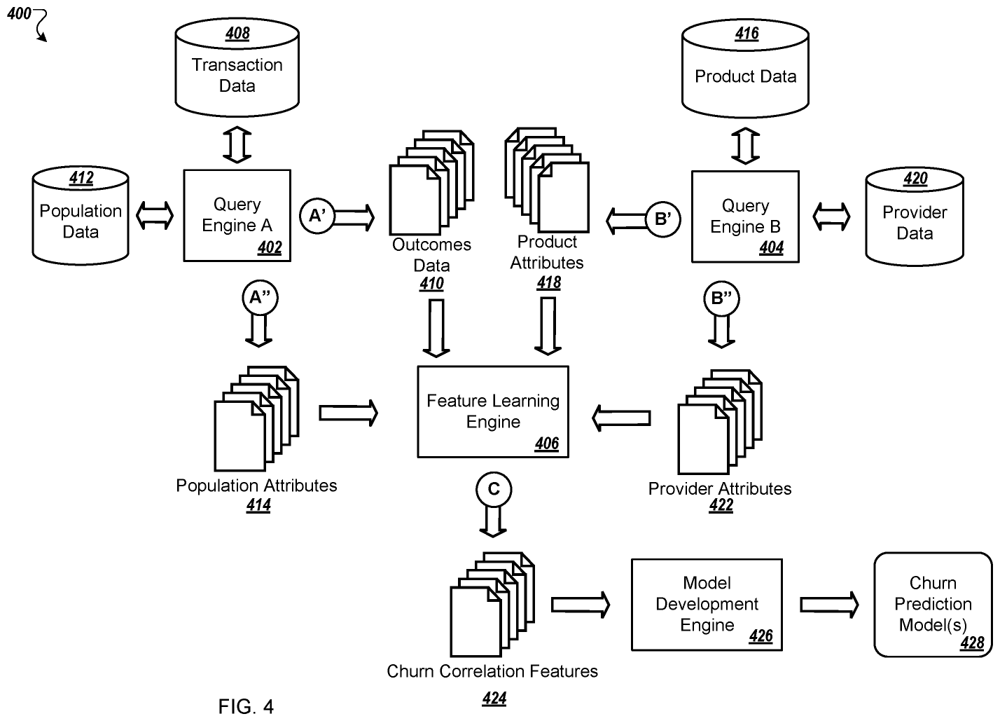

Turning to FIG. 4, an operational flow diagram illustrates an example process 400 for identifying features indicative of propensity for subscriber churn. The process 400 may be executed by the feature learning engine 324 of FIG. 3. Features identified by the process 400 may be included in one or more models for predicting subscriber churn, such as the models applied by the churn risk analysis engine 326 of FIG. 3 or the churn risk analysis engine 106 of FIG. 1A.

In some implementations, the process 400 begins with obtaining, by a first query engine 402 from transaction data 408, outcomes data 410 identifying churn outcomes related to a population of subscribers, such as the subscribers 308 of FIG. 3. The churn outcomes in the outcomes data 410 may range over a period of time, such as one month, three months, six months, one year, or multiple years. The churn outcomes, in some embodiments, include two possible outcomes (remained with previous provider, did not remain with previous provider). In other embodiments, the churn outcomes include additional outcomes such as, in some example, renewed same product with previous provider, remained with previous provider but changed product, remained with previous provider and subscribed to additional product(s), switched to different provider within the platform, and/or did not purchase a subscription associated with the platform. Each churn outcome is associated with a particular subscriber within a subscriber population.

The outcomes data 410, in some embodiments, includes one or more subscription products associated with each outcome. Each product may be associated with transaction characteristics such as, in some examples, subscription purchase data (e.g., date, product, cost, coverage, etc.), payments data (e.g., dates and amounts of payments, indications of past due payments, type of payment schedule established between customer and provider, etc.), service request data (e.g., insurance claims data), customer support interactions data (e.g., technical support interactions, product support interactions, invoicing or billing support interactions, user information updating interactions, etc.), customer communications data (e.g., calls placed between provider and customer, electronic messages between provider and customer, accesses by customer to customer portal or provider web site, etc.), and/or discount data (e.g., any redeemed offers, coupons, discounted services, repeat customer adjustments, etc. applied to subscription price).

In some implementations, the first query engine obtains, from population data 412, population attributes 414 regarding a subscriber population. The population data 412 may vary based upon timeframe. For example, a same subscriber may be associated with a different geographical region during one time period than another time period. Each subscriber in the population data 412 may be associated with particular population characteristics such as, in some examples, length of relationship with provider, number of times the subscriber has previously churned, geographic region, industry, financial data, and length of relationship with platform (e.g., as a subscriber of any provider).

In some implementations, the second query engine obtains, from product data 416, product attributes 418 regarding products from which subscribers did or did not churn. The product attributes 418 may differ from provider to provider for similar products. Additionally, product offerings may vary from year to year. Thus, the product attributes 418 may each correlate to a particular provider and a particular year, for example to align with each churn event and each renewal event. Differences in product attributes between providers may have an impact on subscriber churn rate.

The second query engine, in some implementations, obtains from provider data 420 provider attributes 422 regarding multiple providers of subscription products. The provider attributes 422, in some examples, may include features such as size, breadth of product offerings, age, financial security (e.g., credit rating), and geographic region. Further, the provider attributes 422 may include relative characteristics such as, in some examples, rank within industry or industry segment, market share, and/or one or more consumer ratings such as customer service expertise, claims handling, subscription product value rating/ranking (e.g., within platform or through independent source(s)), subscription product reliability (e.g., within platform or through independent source(s)), and/or date of addition to the subscription exchange platform. Additionally, the provider attributes 422 may include product relevant characteristics such as, in some examples, product distribution methods, subscriber communications methods, payment methods, and/or product features (e.g., product lines, subscription benefits, etc.). The provider attributes 422 may be associated with both a provider and a year or other time period, since provider attributes can change over time.

In some implementations, a feature learning engine 406 obtains the provider attributes 422, the population attributes 414, the outcomes data 410, and the product attributes 418 and analyzes the information to determine a set of churn correlation features 424 identifying attributes and values or value ranges correlated with propensity to churn. Certain churn correlation features 424, in turn, may correspond to a particular product, product type, or population segment. Further, some correlation features 424 may be identified as sets of features (e.g., product type A and population segment B and provider characteristic C corresponds to a heightened likelihood of churn).

The churn correlation features 424, in some implementations, are used to populate additional models for predicting churn. For example, the churn correlation features 424 may be obtained by a model development engine 426 to develop one or more churn prediction models 428 using, for each model, a portion of the churn correlation features 424. The model development engine 426, for example, may obtain training data from historic records (e.g., transaction data 408, population data 412, product data 416, and/or provider data 420) to train the churn prediction models 428 for use by a churn prediction engine such as the churn risk analysis engine 106 of FIG. 1A or the churn risk analysis engine 326 of FIG. 3. Therefore, the ability of the feature learning engine 406 and model development engine 426 to adapt to newly learned correlations between attributes of data associated with subscription product transactions (e.g., outcomes data 410, product attributes 418, population attributes 414, and provider attributes 422) provides a technical solution to the technical problem of automating the prediction of subscriber churn in real-time in a way that adapts to a continuously changing subscription product transaction environment.

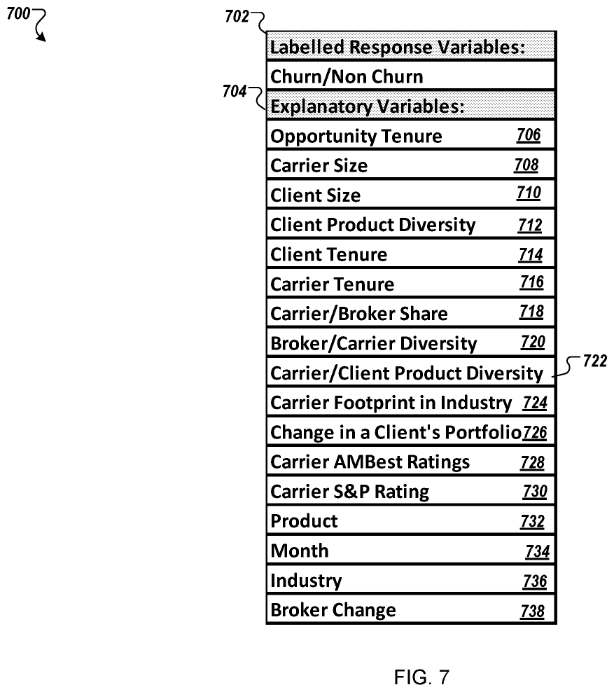

FIG. 7 illustrates a set of example churn correlation features 700 that can be used by the model development engine 426 to train the churn prediction models 428 along with historic records (e.g., transaction data 408, population data 412, product data 416, and/or provider data 420). In some implementations, the churn correlation features 700 can include a combination of features that are learned based on determined correlations of relationships between the features and whether the features can be used to predict churn and/or features identified by participants in the environment 300 (FIG. 3) through surveys and/or other feedback. In some examples, the features 700 can include labelled response variables 702 as well as explanatory variables 704. In some embodiments, the labelled response variables 702 can indicate whether the respective subscriber or client churned from the respective provider or not. The labelled response variables, in some examples, can assist the churn prediction models 428 in learning patterns of explanatory variables 704 that cause a client to churn from a given provider.

In some implementations, the explanatory variables 704 can include features that explain characteristics of the relationships between clients (e.g., subscribers 308), carriers (subscription providers 304), and/or brokers. For example, the explanatory variables 704 can include opportunity tenure 706 (number of unbroken years that a client placed a local product with a carrier up to the most recent year), carrier size 708 (e.g., based on banded annual premium sum), client size 710 (e.g., based on banded annual premium sum), client product diversity 712 (e.g., number of products a client purchased from the provider in the most recent year), client tenure 714 (e.g., number of years a client has been registered with the system), carrier tenure 716 (e.g., number of years a carrier has been registered with the system), carrier/broker share 718 (e.g., proportion of premium held by the broker in the carrier's share), broker/carrier diversity 720 (e.g., number of carriers a broker placed within a most recent year), carrier/client product diversity 722 (e.g., number of products a client has with a carrier over the last year), carrier footprint in industry 724 (e.g., proportion of premium held by the carrier in the local product and/or industry space), change in client's portfolio 726 (e.g., percentage change in premium over last number of years, percentage change in number of products over last number of years), carrier ratings 728 (e.g., carrier rating issued through A.M. Best Rating Services, Inc.), carrier credit rating 730 (e.g., S&P credit score for the carrier that describes general credit worthiness), renewal product 732, month of policy effective date 734, industry of client 736, and broker change 738 (e.g., whether the client has changed brokers in the past year). In some examples, the explanatory variables 704 can be broken down into categories associated with clients, products, brokers, and carriers.

A portion of the explanatory variables 704, in some implementations, can be used to model the interactions and/or relationships between the clients, products, brokers, and carriers. In some embodiments, the subscription product management system 302 may be configured to intervene to mitigate churn not just based on relationships between carriers (providers 304) and clients (subscribers 308), but also based on relationships between providers 304 and brokers 306 and/or relationships between subscribers 308 and brokers 306. Additionally, the system 302 can be configured to determine and mitigate the effects of a carrier churning from a particular broker or vice versa. It can be understood that any of the examples of churn prediction provided herein can also apply to churn by carriers (providers 304), clients (subscribers 308) away from brokers 306, and/or brokers 306 away from carriers.

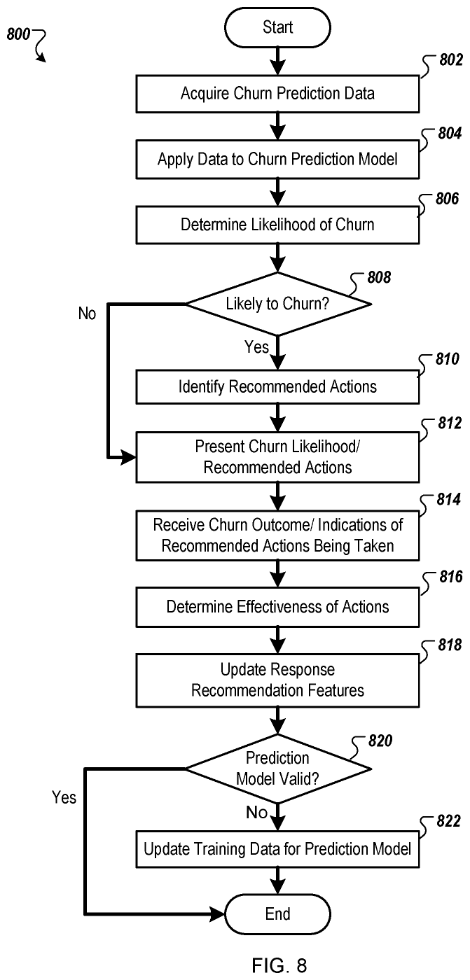

Turning to FIG. 8, a flow chart of an example method of predicting and mitigating subscriber churn 800 is illustrated. In some implementations, the method 800 can be performed by a portion of the processing engines and resources of the subscription product management engine 302 (FIG. 3). For example, one or more portions of the method can be performed by churn analysis risk engine 326, GUI engine 328, model validation engine 330, response recommendation engine 332, and/or response validation engine 334.

In some embodiments, the method 800 commences with acquiring churn prediction data for a set of subscribers, such as clients of a carrier and/or broker (802). In some examples, the churn prediction data can include product data 338, subscriber data 340, provider data 342, population data 344, survey data 346, and/or transaction data 348.

In some implementations, churn risk analysis engine 326 can apply the churn prediction data to a churn prediction model to determine weighting factors for the subscribers, which indicates a likelihood of churn (804). In some examples, the churn risk analysis engine 326 can use the weighting factors output by the model to determine whether each of the subscribers is likely to churn away from a product and/or a provider of the product (806). The churn risk analysis engine 326 may apply one or more likelihood thresholds for separating the customers by relative likelihood to churn.

If the churn risk analysis engine 326 determines that one or more subscribers are likely to churn (808), then in some implementations, response recommendation engine 332 can determine one or more actions for mitigating the risk of churn for each of those subscribers (810). In some examples, the recommended actions can include personal contact, marketing email, promotional offer, discount, or another mechanism for enticing each customer of the customer set 126a to remain with the subject provider. In some examples, the response recommendation engine 332 can also determine recommended actions for subscribers that do not meet the threshold churn likelihood and/or have a very small likelihood of churn but can still improve the chances that the subscriber will remain with the provider.

The GUI engine 328, in some embodiments, presents the churn prediction results and/or recommended actions for mitigating the risk of churn to the respective subscription providers via one or more GUI screens (812). In some implementations, the system can also receive inputs from providers regarding which of the recommended actions were taken via one or more GUI screens, and subscribers and/or providers can provide the system with subscriber product selections that indicate the outcome for whether or not the subscriber churned away from the respective product and/or provider (814). For example, if the client renewed the product with the same provider, then the client did not churn. On the other hand, client churn may have occurred if the client switched to a different provider and/or product at a product renewal period.

Based on the churn outcome, in some implementations, the response validation engine 334 can determine the effectiveness of the recommended actions (816) and update response recommendation features based on the effectiveness or ineffectiveness of a given recommendation (818). Additionally, in some implementations, the churn outcomes for the subscribers can be used by the model validation engine 330 to determine how accurate the churn prediction models are and whether they should be updated (820). In some implementations, if the churn prediction model did not accurately predict the likelihood of client churn for a portion of the subscribers, then the model validation engine 330 may provide this feedback to the algorithm training engine 322 to update the training data for the churn prediction models (822). In some implementations, the algorithm training engine 322 may also update the training data to reflect the churn outcomes that the churn prediction model was able to predict accurately.

Although illustrated in a particular series of events, in other implementations, the steps of the prediction and mitigation of subscriber churn process 800 may be performed in a different order. For example, determining the validity of the churn prediction models (820) may be performed before, after, or simultaneously with determining effectiveness of recommended actions (816). Additionally, in other embodiments, the prediction and mitigation of subscriber churn process 800 may include more or fewer steps while remaining within the scope and spirit of the process 800.

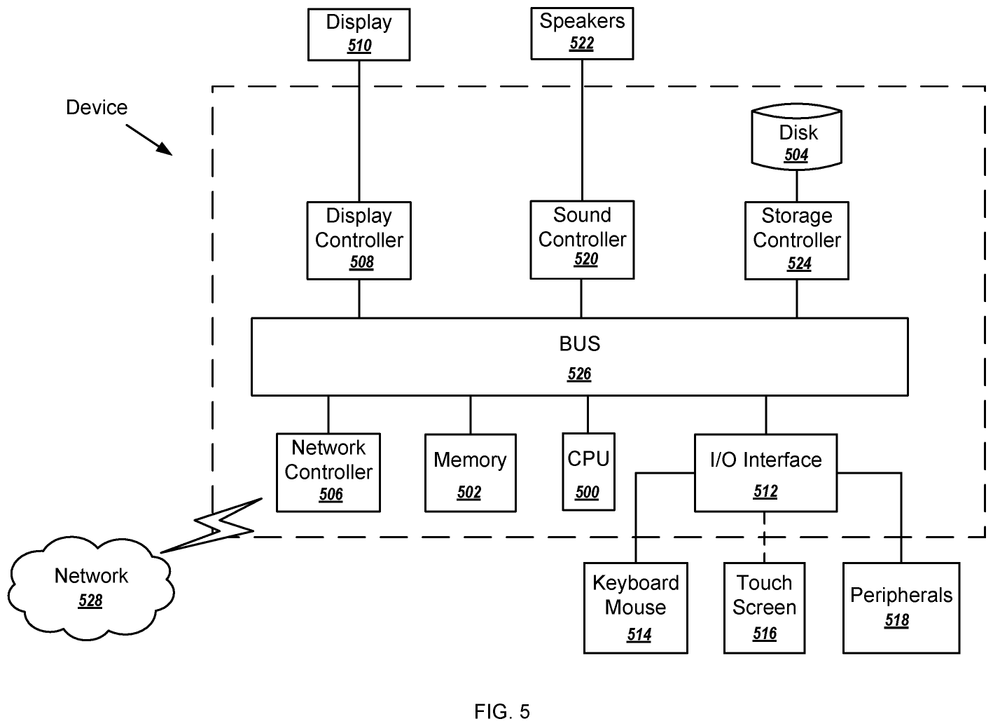

Next, a hardware description of the computing device, mobile computing device, or server according to exemplary embodiments is described with reference to FIG. 5. The computing device, for example, may represent one or more computing systems supporting the functionality of the subscription providers 304, the subscription brokers 306, the subscribers 308, and/or one or more computing systems supporting the functionality of the subscription product management system 302, as illustrated in FIG. 3. In FIG. 5, the computing device, mobile computing device, or server includes a CPU 500 which performs the processes described above. The process data and instructions may be stored in memory 502. The processing circuitry and stored instructions may enable the computing device to perform, in some examples, the process 100 of FIG. 1A and FIG. 1B, the process 200 of FIG. 2, and/or the process 400 of FIG. 4. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device, mobile computing device, or server communicates, such as a server or computer. The storage medium disk 504, in some examples, may store the contents of the customer data 112, provider data 108, survey data, and/or transaction data 118 of FIG. 1A, the customer risk weightings 122, the likelihood thresholds 130, and/or prediction data 128 of FIG. 1B, the interaction data 220, churn avoidance metrics 222, model validity metrics 216, and/or transaction data 212 of FIG. 2, the contents of the data repository 310 of FIG. 3, and/or the population data 412, transaction data 408, product data 416, provider data 420, churn correlation features 424, and/or churn prediction model(s) 428 of FIG. 4.

Further, a portion of the claimed advancements may be provided as a utility application, background daemon, or component of an operating system, or combination thereof, executing in conjunction with CPU 500 and an operating system such as Microsoft Windows 10, UNIX, Solaris, LINUX, Apple MAC-OS and other systems known to those skilled in the art.

CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The computing device, mobile computing device, or server in FIG. 5 also includes a network controller 506, such as an Intel Ethernet PRO network interface card from Intel Corporation of America, for interfacing with network 528. As can be appreciated, the network 528 can be a public network, such as the Internet, or a private network such as an LAN or WAN network, or any combination thereof and can also include PSTN or ISDN sub-networks. The network 528 can also be wired, such as an Ethernet network, or can be wireless such as a cellular network including EDGE, 3G, 4G, and 5G wireless cellular systems. The wireless network can also be Wi-Fi, Bluetooth, or any other wireless form of communication that is known. The network 528, for example, may support communications between the subscription product management system 302 and any one of the subscription providers 304, subscription brokers 306 and subscribers 308.

The computing device, mobile computing device, or server further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface also connects to a variety of peripherals 518 including printers and scanners, such as an OfficeJet or DeskJet from Hewlett Packard. The display controller 508 and display 510 may enable presentation of user interfaces generated by the GUI engine 136 of FIG. 1B or the GUI engine 328 of FIG. 3.

A sound controller 520 is also provided in the computing device, mobile computing device, or server, such as Sound Blaster X-Fi Titanium from Creative, to interface with speakers/microphone 522 thereby providing sounds and/or music.

The general purpose storage controller 524 connects the storage medium disk 504 with communication bus 526, which may be an ISA, EISA, VESA, PCI, or similar, for interconnecting all of the components of the computing device, mobile computing device, or server. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

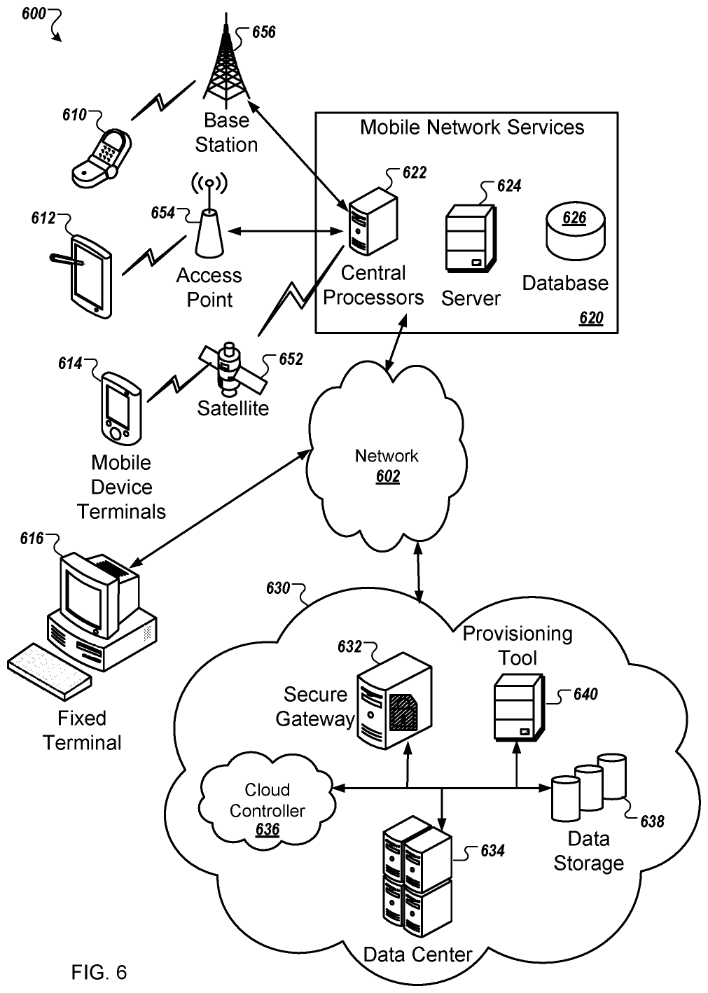

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 6, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 630, such as Google Cloud Platform™ to perform at least portions of methods or algorithms detailed above. The processes associated with the methods described herein can be executed on a computation processor, such as the Google Compute Engine by data center 634. The data center 634, for example, can also include an application processor, such as the Google App Engine, that can be used as the interface with the systems described herein to receive data and output corresponding information. The cloud computing environment 630 may also include one or more databases 638 or other data storage, such as cloud storage and a query database. In some implementations, the cloud storage database 638, such as the Google Cloud Storage, may store processed and unprocessed data supplied by systems described herein. For example, the customer data 112, provider data 108, survey data, and/or transaction data 118 of FIG. 1A, the customer risk weightings 122, the likelihood thresholds 130, and/or prediction data 128 of FIG. 1B, the interaction data 220, churn avoidance metrics 222, model validity metrics 216, and/or transaction data 212 of FIG. 2, the contents of the data repository 310 of FIG. 3, and/or the population data 412, transaction data 408, product data 416, provider data 420, churn correlation features 424, and/or churn prediction model(s) 428 of FIG. 4 may be maintained in a database structure such as the databases 638.

The systems described herein may communicate with the cloud computing environment 630 through a secure gateway 632. In some implementations, the secure gateway 632 includes a database querying interface, such as the Google BigQuery platform. The data querying interface, for example, may support access by the subscription product management system 302 to data stored on any one of the subscription providers, subscription brokers 306 and subscribers 308. Further, the data querying interface may support access by any of the query engines 102, 104 of FIG. 1A, the query engines 202, 208, and 210 of FIG. 2, and the query engines 402, 404 of FIG. 4.

The cloud computing environment 630 may include a provisioning tool 640 for resource management. The provisioning tool 640 may be connected to the computing devices of a data center 634 to facilitate the provision of computing resources of the data center 634. The provisioning tool 640 may receive a request for a computing resource via the secure gateway 632 or a cloud controller 636. The provisioning tool 640 may facilitate a connection to a particular computing device of the data center 634.

A network 602 represents one or more networks, such as the Internet, connecting the cloud environment 630 to a number of client devices such as, in some examples, a cellular telephone 610, a tablet computer 612, a mobile computing device 614, and a desktop computing device 616. The network 602 can also communicate via wireless networks using a variety of mobile network services 620 such as Wi-Fi, Bluetooth, cellular networks including EDGE, 3G, 4G, and 5G wireless cellular systems, or any other wireless form of communication that is known. In some examples, the wireless network services 620 may include central processors 622, servers 624, and databases 626. In some embodiments, the network 602 is agnostic to local interfaces and networks associated with the client devices to allow for integration of the local interfaces and networks configured to perform the processes described herein. Additionally, external devices such as the cellular telephone 610, tablet computer 612, and mobile computing device 614 may communicate with the mobile network services 620 via a base station 656, access point 654, and/or satellite 652.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A system for predicting subscriber churn, comprising:
processing circuitry; and
a non-transitory computer readable medium having instructions stored thereon, wherein the instructions, when executed by the processing circuitry, cause the processing circuitry to
access, from one or more data sources via a network, historic attribute data representing relationships between participants in transactions for purchasing a plurality of subscription products, wherein
the participants include a plurality of subscription product providers and a plurality of subscription product subscribers, and
the historic attribute data spans a timeframe including a plurality of subscription renewal periods,
identify, based on detected correlations between items of the historic attribute data, one or more correlation features for training a churn prediction model to determine a likelihood of churn, wherein
the likelihood of churn represents a relative likelihood that a given subscriber of the plurality of subscription product subscribers will churn away from a respective provider of the plurality of subscription product providers upon product renewal of the respective subscription product of the plurality of subscription products,
for each subscriber of a plurality of current subscribers of the plurality of subscription products,
determine, based on application of one or more churn prediction attributes for the respective subscriber to the trained churn prediction model, a predicted likelihood of churn away from a respective provider of the plurality of providers,
wherein the one or more churn prediction attributes define a relationship between the respective subscriber and the respective provider in view of a respective subscription product of the plurality of subscription products, and
present, to a remote computing device of the respective provider via the network, information identifying a portion of the plurality of current subscribers, each subscriber of the portion being determined to have a respective predicted likelihood of churn identified as a high likelihood, for mitigating the predicted likelihood of churn away from the respective provider.

2. The system of claim 1, wherein the one or more churn prediction attributes defining the relationship between the respective subscriber and the respective provider include survey data results received from a second remote computing device of the respective subscriber via the network, wherein
the survey data results indicate a level of contentment of the respective subscriber with the respective product provided by the respective provider.

3. The system of claim 1, wherein the one or more churn prediction attributes defining the relationship between the respective subscriber and the respective provider include transaction data indicating attributes of interactions between the respective subscriber and the respective provider over a subscription period of the respective product.

4. The system of claim 1, wherein churning away from the respective provider includes at least one purchasing the respective product from another provider of the plurality of providers or dropping the respective product upon product renewal.

5. The system of claim 1, wherein applying the one or more churn prediction attributes for the respective subscriber to the trained churn prediction model produces a subscriber weighting representing a relative propensity for the respective subscriber to churn away from the respective provider.

6. The system of claim 5, wherein determining the predicted likelihood of churn away from the respective provider comprises
identifying, based upon the subscriber weighting, the respective subscriber as having the high likelihood of churn based on the subscriber weighting exceeding a threshold.

7. The system of claim 1, wherein, for each subscriber of the portion of the plurality of current subscribers determined to have a respective predicted likelihood of churn identified as the high likelihood, the instructions cause the processing circuitry to:
identify, based on a portion of the one or more churn prediction attributes, a respective one or more recommended actions for mitigating the predicted likelihood of churn away from the respective provider; and
present, at the remote computing device of the respective provider via the network, the one or more recommended actions.

8. The system of claim 7, wherein the one or more recommended actions include at least one of personal contact, a marketing email, a promotional offer, or a discount offered by the respective provider to the respective subscriber.

9. The system of claim 7, wherein identifying the one or more recommended actions comprises associating a respective recommended action with an attribute of a transaction between the respective subscriber and the respective provider.

10. The system of claim 7, wherein the instructions, when executed by the processing circuitry, cause the processing circuitry to
determine, (a) responsive to receiving indication from the remote computing device of the respective provider indicating that a portion of the one or more recommend actions were taken and (b) based on a comparison of the predicted likelihood of churn to a churn outcome for the respective subscriber, an effectiveness of the portion of the one or more recommended actions in mitigating the predicted likelihood of churn away from the respective provider.

11. The system of claim 1, wherein the instructions, when executed by the processing circuitry, cause the processing circuitry to, after a timeframe of the product renewal, update, based on an accuracy of the churn prediction model in predicting the churn of the respective subscriber away from the respective provider, the one or more correlation features for training the churn prediction model,
wherein the accuracy of the churn prediction model is based at least in part on a comparison of the predicted likelihood of churn to a churn outcome for the respective subscriber.

12. The system of claim 1, wherein the plurality of subscription products includes at least one of media subscriptions, insurance policies, or gym memberships.

13. The system of claim 1, wherein the items of historic attribute data include attributes of the plurality of subscription product providers, attributes of the plurality of subscription product subscribers, attributes of the plurality of subscription products, and churn outcomes for the plurality of subscription product subscribers over a predetermined period of time.

14. A method for predicting customer churn, comprising:
for each customer of a plurality of product customers participating in transactions to purchase a plurality of renewable products from a plurality of product providers,
determining, by processing circuitry based on application of one or more churn prediction attributes for the respective customer to a trained churn prediction model, a predicted likelihood that the respective customer will churn away from a respective product of the plurality of renewable products,
wherein the one or more churn prediction attributes define a relationship between the respective customer to a respective provider of the plurality of product providers providing the respective product, and
wherein the predicted likelihood of churn represents a relative likelihood that the respective customer will churn away from the respective product upon product renewal;
identifying, by the processing circuitry based on a portion of the one or more churn prediction attributes, one or recommended actions for mitigating the predicted likelihood of churn away from the respective product;
presenting, by the processing circuitry to a remote computing device of the respective provider of the respective product via a network, the predicted likelihood of churn and the one or more recommended actions for mitigating the predicted likelihood of churn; and
updating, by the processing circuitry based on an accuracy of the churn prediction model in predicting the churn of the respective customer away from the respective product, one or more correlation features for training the churn prediction model,
wherein the accuracy of the churn prediction model is based on a comparison of the predicted likelihood of churn to a churn outcome for the respective customer.

15. The method of claim 14, wherein the one or more recommended actions include at least one of personal contact, a marketing email, a promotional offer, or a discount offered by the respective provider to the respective customer.

16. The method of claim 14, wherein identifying the one or more recommended actions comprises associating a respective recommended action with an attribute of a transaction between the respective customer and the respective provider.

17. The method of claim 14, wherein the plurality of renewable products includes at least one of media subscriptions, insurance policies, or gym memberships.

18. The method of claim 14, further comprising:
determining, (a) responsive to receiving indication from the remote computing device of the respective provider indicating that a portion of the one or more recommend actions were taken and (b) based on the comparison of the predicted likelihood of churn to the churn outcome for the respective customer, an effectiveness of the portion of the one or more recommended actions in mitigating the predicted likelihood of churn away from the respective product.

19. The method of claim 14, further comprising:
identifying, based on detected correlations between items of historic attribute data representing relationships between the plurality of product providers and the plurality of product customers, the one or more correlation features for training the churn prediction model to determine the predicted likelihood that each customer of the plurality of product customers will churn away from the respective product.

20. The method of claim 19, further comprising, after a timeframe of the product renewal, updating, based on an accuracy of the churn prediction model in predicting the churn of the respective subscriber away from the respective product, the one or more correlation features for training the churn prediction model,
wherein the accuracy of the churn prediction model is based on a comparison of the predicted likelihood of churn to a churn outcome for the respective subscriber.
